(19) United States
(12) Patent Application Publication
(10) Pub. No.: US 2026/0277552 A1
(43) Pub. Date: Sep. 17, 2026

(54) SYSTEMS AND METHODS FOR CODE GENERATION WITH AN APPLICATION BINARY INTERFACE

(71) Applicant: NVIDIA Corporation, Santa Clara, CA (US)

(72) Inventor: Jeremy David FURTEK, San Antonio, TX (US)

(73) Assignee: NVIDIA Corporation, Santa Clara, CA (US)

(21) Appl. No.: 19/081,551

(22) Filed: Mar. 17, 2025

(51) Int. Cl. G06F 8/30; G06F 8/41; G06F 11/3604

(52) U.S. Cl. CPC G06F 8/30; G06F 8/41; G06F 11/3604

(57) ABSTRACT

In various examples, a compiled code having a host program and a device program is generated with a definition for an application binary interface (ABI). The ABI facilitates communication of data/instructions between a CPU and a GPU while sending only data dynamic data over the ABI. Systems and methods identify a structure of data to be communicated over the ABI. A function for a second coding language is selected to generate the structure without static variables. The function for the second coding language can be used to generate host and device instructions for execution on a host device. When data is communicated over the ABI without the static variables, it is combined with the missing data of the static variable within the destination. Explicit elimination of certain data transmitted over the API can have significant impact over the number of computations performed by the compiler.

### BACKGROUND

Host devices use an application binary interface (ABI) to communicate information and commands between a central processing unit (CPU) and a graphics processing unit (GPU). Compilers perform multiple passes to convert instructions provided by a developer in a high-level programming language (e.g., Python, C languages, etc.) to lower-level machine code capable of running on the CPU and GPU. ABIs are used to communicate layouts of memory allocations. Long compile times can occur when the compiler makes multiple passes to optimize code. For large programs, long delays can occur while compiling, for example, between a time the code is ready for compiling and a time a debugger can execute the code.

### SUMMARY

Implementations of the present disclosure relate to code generation for systems with an application binary interface (ABI). Systems and methods are disclosed that decrease compilation time by defining library functions that reduce the amount of data that is transferred over an ABI. For example, the ABI can be used to communicate commands and parameters for the commands between a central processing unit (CPU) and graphics processing unit (GPU) of a host device. Systems and methods disclosed herein can identify structures, within a first code (e.g., instructions, operations, procedures, etc.), having data that are to be communicated over the ABI. The data includes parameters defining a command for the GPU, for example, a layout or shape or stride related to a memory or processing unit allocation. A function for a second code (e.g., lower-level, lowered, assembly, etc.) can be selected for communicating the data of the structure without communicating statically defined variables (e.g., those variables for which the values is known to the compiler at compilation time or the time of code generation).

A host program (e.g., for the CPU) and a device program (e.g., for the GPU) can be created using the function for the second code. The host program and the device program may share or use an ABI that allows the parameters of the structure to be communicated without the statically defined variables. In some implementations, only the dynamic variables (e.g., those variables that obtain a value only during runtime) are communicated over the ABI. The information related to the static variables can be recombined with the dynamic variables after the dynamic variables have been transferred. For example, both the host program and the device program are generated with the knowledge of the values of the static variables that will not be transmitted. This information is instilled into the programs during the compilation process using the function for the second code.

In contrast to conventional systems, several passes of the compilation procedure can be skipped or made more efficient because the statically defined variables are explicitly eliminated within the code. For example, the function for the second code does not emit (e.g., create, generate, etc.) any code for the communicating the static variables. By not performing all passes or as many operations within the compiler, the number of computations performed by a compiler is reduced while maintaining a high level of performance in the final program executed on the host. Reducing the number of computations has a direct effect on the overall energy consumption during compilation and the time spent by a developer waiting for compilation to complete.

At least one aspect relates to a one or more processors comprising processing circuitry to identify, in a first code, a first structure comprising one or more parameters defining an operation to be performed, wherein the one or more parameters comprise a static variable. The processing circuitry can also select a function for a second code to generate a second structure comprising the one or more parameters of the first structure without the static variable. The processing circuitry can also generate, using the function, a first program to transfer the second structure to a second program and generate the second program using the static variable. The second program is to receive the second structure and perform the operation without receiving the static variable at a time the second program is being executed.

In some implementations, the first program is a host program to be executed by a central processing unit and the second program is a s program is to be executed on a graphics processing unit. In some implementations, the operation comprises a memory allocation within the second program. In some implementations, the one or more parameters indicate a shape and a stride for the memory allocation. In some implementations, the first structure comprises a plurality of nesting levels for the one or more parameters and the second structure comprises the one or more parameters of the first structure without the static variable at a single nesting level. In some implementations, the second code is of an intermediate programming language and generated from the first code used to generate the second program and the first program.

Another aspect relates to a system with one or more processors. The one or more processors can identify, in a first code, a first structure comprising one or more parameters defining an operation to be performed, wherein the one or more parameters comprise a static variable. The one or more processors can also select a function for a second code to generate a second structure comprising the one or more parameters of the first structure without the static variable. The one or more processors can also generate, using the function, a first program to transfer the second structure to a second program and generate the second program using the static variable, wherein the second program is to receive the second structure and perform the operation without receiving the static variable at a time the second program is being executed.

In some implementations, the first program is a host program to be executed by a central processing unit and the second program is a device program to be executed on a graphics processing unit. In some implementations, the operation comprises a memory allocation within the second program. In some implementations, the one or more parameters indicate a shape and a stride for the memory allocation. In some implementations, the first structure comprises a plurality of nesting levels for the one or more parameters and the second structure comprises the one or more parameters of the first structure without the static variable at a single nesting level. In some implementations, the second code is of an intermediate programming language and generated from the first code used to generate the second program and the first program.

Another aspect of the present disclosure relates to a method. The method includes identifying, in a first code, a first structure comprising one or more parameters defining an operation to be performed, wherein the one or more parameters comprise a static variable. The method also includes selecting a function for a second code to generate a second structure comprising the one or more parameters of the first structure without the static variable. The method also includes generating, using the function, a first program to transfer the second structure to a second program and generating the second program using the static variable, wherein the second program is to receive the second structure and perform the operation without receiving the static variable at a time the second program is being executed.

In some implementations, the first program is a host program to be executed by a central processing unit and the second program is a device program is to be executed on a graphics processing unit. In some implementations, the operation comprises a memory allocation within the second program and the one or more parameters indicate a shape and a stride for the memory allocation. In some implementations, the first structure comprises a plurality of nesting levels for the one or more parameters and the second structure comprises the one or more parameters of the first structure without the static variable at a single nesting level. In some implementations, the second code is of an intermediate programming language and generated from the first code used to generate the second program and the first program.

### BRIEF DESCRIPTION OF THE DRAWINGS

The present systems and methods for code generation with an application binary interface are described in detail below with reference to the attached drawing figures, wherein:

FIG. 1 is a functional block diagram of an example system for generating code having an application binary interface (ABI) suitable for use in implementing at least some implementations of the present disclosure.

FIG. 2 is another functional block diagram of an example system for generating code having an ABI showing propagation of information related to static variables and suitable for use in implementing at least some implementations of the present disclosure.

FIG. 3 is a function block diagram of the host device with ABI suitable for use in implementing at least some implementations of the present disclosure.

FIG. 4 is a flow diagram of an example method for generating code having an application binary interface (ABI) suitable for use in implementing at least some implementations of the present disclosure.

FIG. 5 is a plot of operations during compiler passes comparing a baseline system and systems and methods according to some implementations of the present disclosure.

FIG. 6A is a block diagram of an example generative language model system suitable for use in implementing at least some implementations of the present disclosure;

FIG. 6B is a block diagram of an example generative language model that includes a transformer encoder-decoder suitable for use in implementing at least some implementations of the present disclosure;

FIG. 6C is a block diagram of an example generative language model that includes a decoder-only transformer architecture suitable for use in implementing at least some implementations of the present disclosure;

FIG. 7 is a block diagram of an example computing device suitable for use in implementing at least some implementations of the present disclosure; and

FIG. 8 is a block diagram of an example data center suitable for use in implementing at least some implementations of the present disclosure.

### DETAILED DESCRIPTION

This disclosure relates to systems and methods for code generation with an application binary interface (ABI). Systems and methods can generate code that is used to transfer parameters from a device on one side of the ABI to a device on the other side of the ABI. For example, object size and memory allocation details can be transferred between host instructions executing on a host computer and kernel instructions operating on a graphics processing unit (GPU). Some systems can rely on a compiler to perform code optimizations, leading to long compilation times.

Compilers can make multiple passes over a set of code, optimizing and lowering the code through multiple stages before arriving at the final representation executed on the hardware. For large code programs, the compilation time can be long and can lead to delays during code development and/or debugging of compile-time errors. Each pass can allow the compiler to apply specific optimizations, at the expense of adding complexity and making issues that arise more challenging to trace to a root cause.

Systems and methods in accordance with the present disclosure can eliminate statically defined variables in structures that communicate object size and memory layout across an application binary interface between the host program and the device program (e.g., a GPU kernel). Certain compiler passes no longer have to perform similar optimizations, saving compiler time while maintaining a high level of performance in the final program executed on the devices.

As used herein, a structure can refer to a grouping of variables. For example, a structure can refer to a set, a group, a tuple, an object, arguments for a function or operation, or any other configuration of variables. While a structure can refer to a class of objects (e.g., instantiated with the signature “struct”), a structure as used herein is not limited to a specific object within a programming language.

For example, the system can acquire a first representation of program code. The system can identify static and dynamic variables in the code. The variables may be used to communicate parameters of an operation that is to be performed in the device program. The system can select a function in a lower programming language that generates a structure having only the parameters using dynamic variables. The system can then generate a host program and a device program. The device program can be generated based on the information included in the static variables of the parameters, and the host program can be generated to only transfer the dynamic variables.

In some implementations, the host program executes on a central processing unit (CPU) and the device program executes on a GPU. The generated code can be used to transfer information related to the shape and layout of arrays and tensors for which the GPU program should allocate memory. In some implementations, the system flattens the structure that is used to communicate information between the host program and the device program. For example, an array layout for memory can include a shape (e.g., an object or structure) describing the number of memory elements in each dimension and a stride (e.g., another object or structure) describing how the elements of the array are mapped onto the memory elements in the device architecture. The layout can be flattened to include a single structure having all values representing the shape and all values representing the stride. In some implementations, the structure is only flattened if it results in a single integer value.

In some implementations, the system can generate a number of programs. Each of the programs uses a particular combination of values for dynamic variables that may be selected from an enumeration of allowable values.

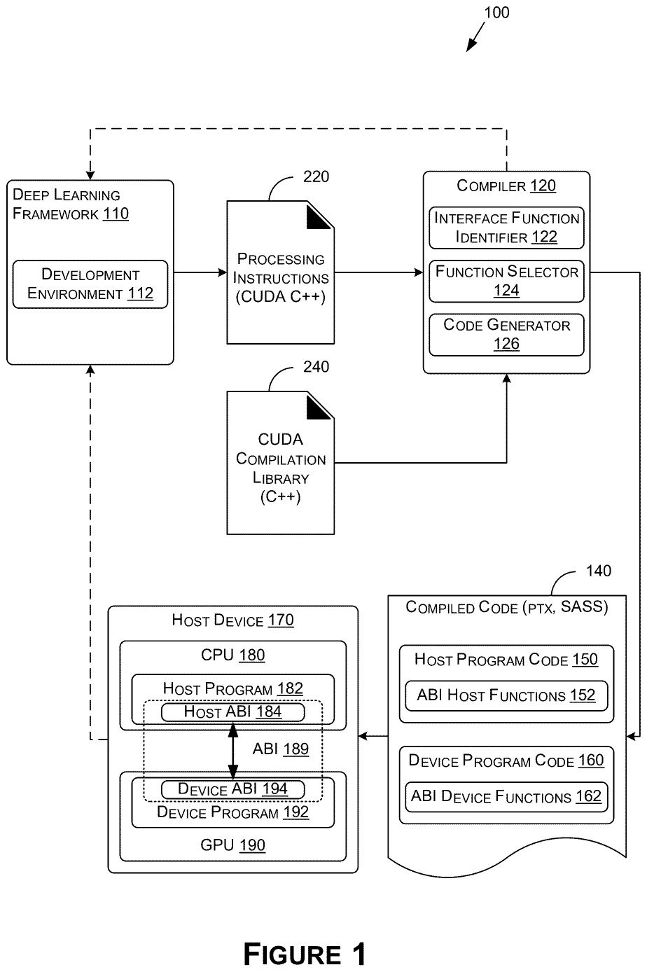

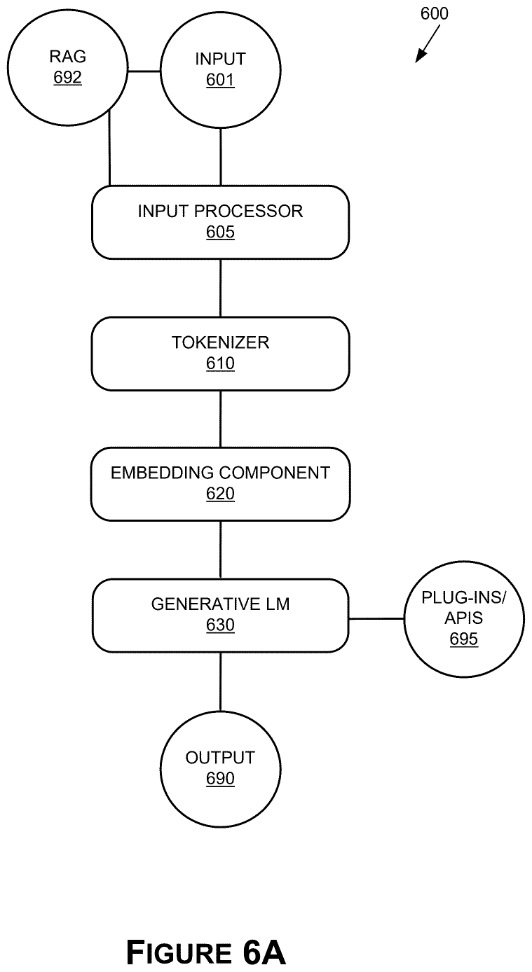

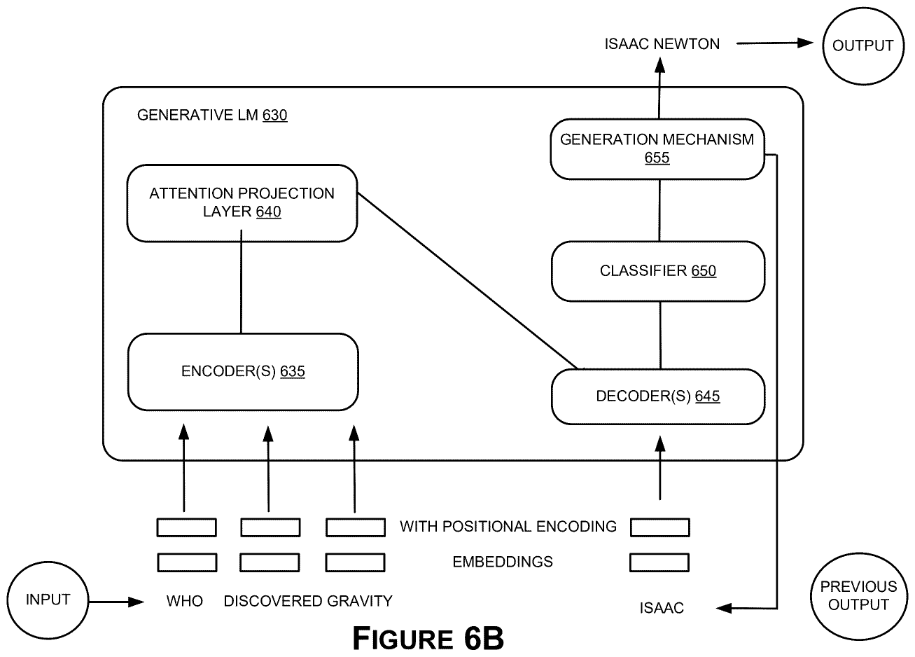

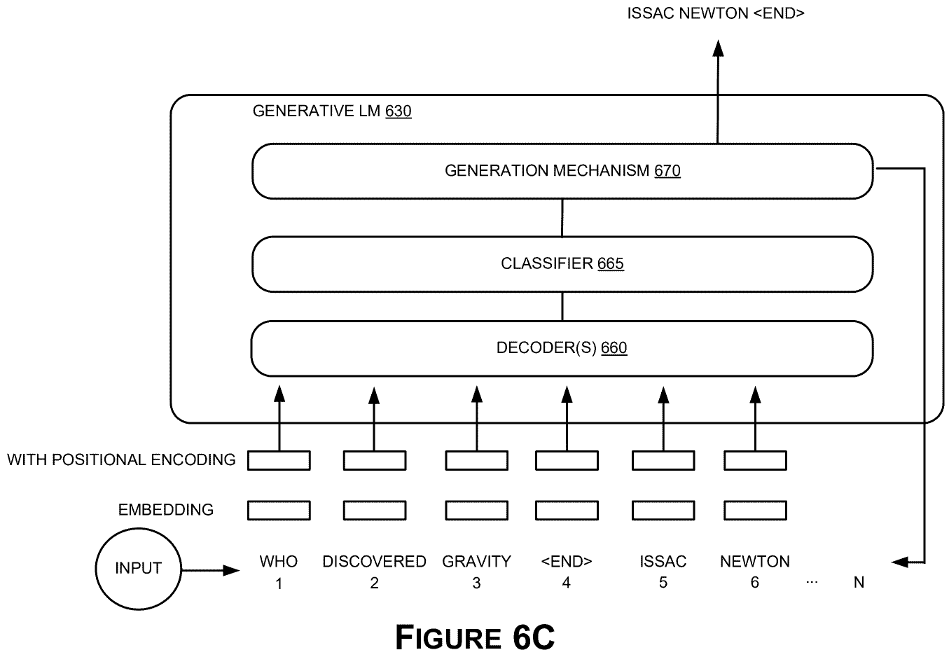

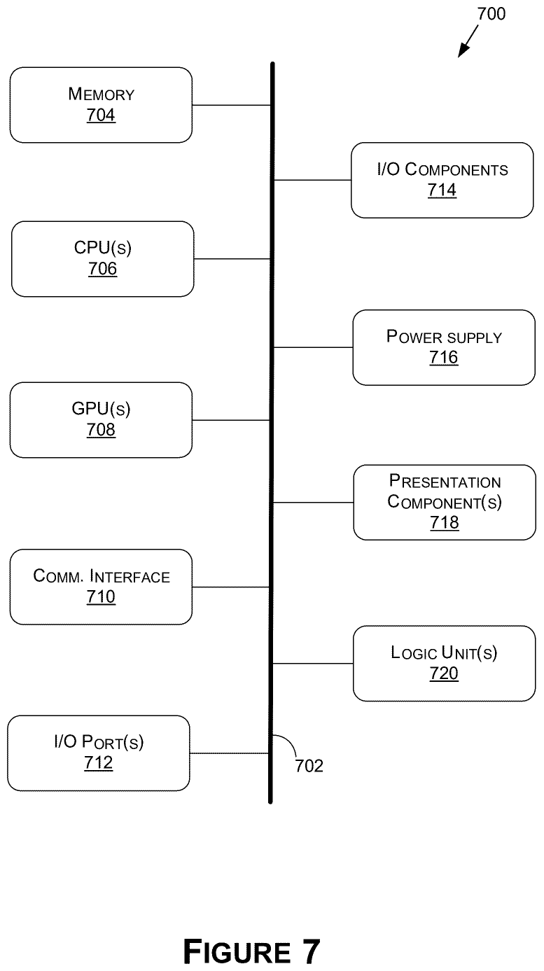

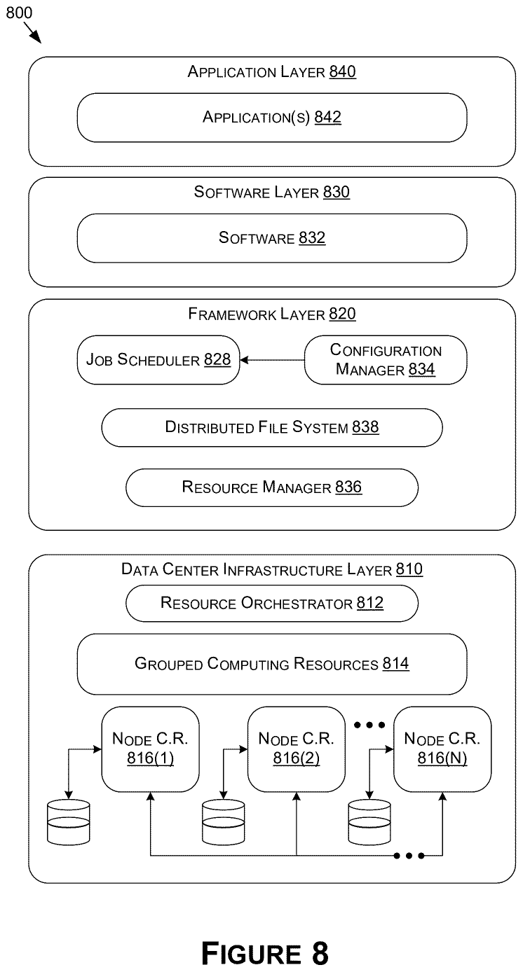

With reference to FIG. 1, FIG. 1 is an example of a system 100 for generating code defining an application binary interface (ABI), in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

The elements of the system 100 may be communicably connected within the system 100. In some implementations, one or more elements of the system 100 are included on the same device (e.g., hardware, computer, processing circuit, etc.). The one or more elements can, for example, be communicably connected over a bus or other hardware connection (e.g., ribbon cables, card edge connector, etc.). In some implementations, one or more elements of the system 100 are distributed across multiple devices. The one or more elements can, for example, be communicably connected over a network. The network can include local networks and/or wide area networks. The network can include routers, switches, antennas, computers, and any other hardware required to communicate information between the elements of the system 100. A portion of the network can be wireless and/or a portion of the network can be wired. The network can include one or more networks with routers to facilitate data transfer between the different networks. In some implementations, one or more elements of the system 100 are configured in a cloud architecture and can be implemented by one or more nodes in a computer cluster. The number of devices (e.g., hardware, computers, processing circuits, etc.) implementing an element in the system 100 can depend on the demand for that functionality. The system 100 can, in some implementations, scale the number of a particular element to add more computation power to a single element.

The system 100 can be used to generate machine executable instructions (e.g., assembly code, code for a device virtual machine, etc.) for deployment and execution on a host device 170. Initial code creation can be performed by a developer (e.g., in a high-level language) using a deep learning framework 110. For example, the developer may be developing a training algorithm for a machine learning model to be deployed on a GPU 190 of the host device 170. Processing instructions 220 created using the deep learning framework 110 (e.g., for the machine learning model or any other application requiring operations to be communicated between two hardware devices of a host) can be processed by the compiler 120, for example, using functions from a compiler library 240 defining conversions from a high-level language to code suitable for execution on the host device 170. Compiled code 140 may include a program for a host central processing unit (CPU) 180 and a program for a graphics processing unit (GPU) 190. The compiled code 140 defines an ABI for data transfer between the CPU 180 and the GPU 190 of the host device 170. Details of these elements of the system 100 and the process performed by the elements are described in more detail herein.

The system 100 can include a deep learning framework 110. The deep learning framework 110 can generate processing instructions that can be used to generate low-level code (e.g., assembly, intermediate representations, machine code, etc.) such as parallel thread execution (ptx) and streaming assembler (SASS) suitable for implementation on a central processing unit (CPU) and/or a graphics processing unit (GPU).

The deep learning framework 110 can include a development environment 112, within which a developer can develop code in a higher-level language. For example, the development environment 112 can provide an integrated environment for developing code, for example and without limitation, in C, C++, Python, C#, R, Rust, F, Ruby, etc. The development environment 112 can include a text editor for creating and editing the code and a debugger for testing the code. In some implementations, the development environment 112 is integrated with an compiler. The development environment 112 can communicate code to the compiler, for example, to generate machine level code that executes instructions within the debugger and/or to generate a lower-level representation (e.g., an intermediate representation, virtual machine code, etc.) of the code for further code generation. In some implementations, the deep learning framework 110 provides an interface for the developer (e.g., within the development environment 112).

The development environment 112 can receive information related to the success or failure of further compilation (e.g., from a compiler 120). The development environment 112 can also receive information related to the success or failure of the execution of the code on a host device 170. For example, the development environment 112 can receive results from the host device 170 as the code is running and/or after it has completed.

The system 100 can include a host device 170 on which compiled code 140 executes. The host device 170 can include multiple hardware devices (e.g., a CPU 180 and a GPU 190). The CPU 180 can perform general computing tasks, orchestrate peripheral devices including the GPU 190, manage interactions, etc. The GPU 190 can perform highly parallelizable tasks such as matrix and/or tensor multiplications. For example, if the host device 170 is currently operating a video game, the CPU 180 can execute overall logic of the game such as AI behavior, physics calculations, and process input/output from/to the player and the GPU 190 can perform calculations related to graphical presentation of the game including textures, lighting, shading etc. in parallel to produce smooth and detailed visuals. In additional examples, if the host device 170 is currently editing a video, the CPU 180 can manage the timeline, apply effects, and handle encoding/decoding, while the GPU 190 can accelerate rendering tasks and speed up the export process by processing video frames in parallel. If the host device 170 is running a machine learning task, the CPU 180 can handle data preprocessing, model setup, and overall orchestration, while the GPU 190 can accelerate model training by performing matrix multiplications and other operations in parallel. If the host device 170 is rendering a 3D scene, the CPU 180 can manage scene setup, including object placement and lighting, while the GPU 190 can perform the actual rendering, calculating pixel colors, textures, and lighting effects in parallel. If the host device 170 is mining cryptocurrency, the CPU 180 can manage the overall mining process, including task scheduling and communication with the mining pool, while the GPU 190 can perform hashing calculations in parallel to solve cryptographic puzzles more efficiently. If the host device 170 is running scientific simulations, the CPU 180 can handle the setup and control of the simulation parameters, while the GPU 190 can perform complex numerical calculations in parallel to simulate physical phenomena more quickly.

In some implementations, the CPU 180 can execute a host program 182 (e.g., defined by a host program code 150 of the compiled code 140) and the GPU 190 can execute a device program 192 (e.g., defined by the device program code 160 of the compiled code 140). During execution of the host program 182, the CPU 180 can communicate information to the device program 192 (e.g., to command or coordinate the operations of the device program 192 with the overall goal of the host program 182). Additionally, the device program 192 may communicate results to the host program 182. The ABI 189 can facilitate communication between the two processes (e.g., host program 182 and device program 192).

The ABI 189 can include a host ABI 184 within the host program 182, and can include a device ABI 194 executed by the device program 192. The host ABI 184 and the device ABI 194 can operate by executing the instructions included in ABI host functions 152 and ABI device functions 162, respectively. The host ABI 184 can create variables and structures to be communicated to the GPU 190. For example, the host ABI 184 can generate a parameter defining an operation (e.g., an operational code or opcode) to communicate an operation that the GPU 190 is to perform. Additionally or alternatively, the host ABI 184 can generate parameters describing the operation (e.g., layout parameters for a tensor allocation).

In some implementations, the host ABI 184 communicates dynamic variables (e.g., variables for which the value is unknown until runtime) using the ABI 189. One or more statically defined variables can be excluded from the information communicated over the ABI 189. The ABI host functions 152 and respective ABI device functions 162 can include information related to statically defined variables (e.g., variables whose values are known to the compiler 120 at a time when the host program code 150 and/or the device program code 160 is compiled) in the instructions executed by the host ABI 184 and the device ABI 194. Using the information communicated over the ABI 189 and the information already included in the device ABI 194, the device ABI 194 can combine the static information and the dynamic information to perform the operation requested by the host program 182. Similarly, the device program 192 can communicate data to the host program 182 via the ABI 189. The device program 192 can communicate dynamic variables using the device ABI 194 while excluding one or more static variables (e.g., relying on common information included in the host program 182 and the device program 192).

The system 100 can include a compiler 120. The compiler 120 can convert the processing instructions 220 into the compiled code 140 for execution on the host device 170. The compiler 120 can also receive additional instructions from the compiler library 240. The compiler library 240, for example, can include code that provides lower-level code (e.g., instructions, operations, etc.) for various functions within the processing instructions 220. The compiler 120 can convert the functions of the processing instructions 220 into lower-level code by executing certain functions within the compiler library 240. Advantageously, the compiler 120 can perform fewer passes or fewer computations to covert the processing instructions 220 into the compiled code 140 using the compiler library 240 provided to the compiler 120.

In some implementations, the compiler 120 can receive processing instructions 220 that indicate a transfer of data between two hardware devices of the host device 170. The data can include statically defined data (e.g., data for which the values are available at compile time). The compiler 120 can generate code for which the statically defined data is not transferred between the two devices, thus minimizing the data transfer and improving execution time. For example, the compiler 120 can include the statically defined data in code for both of the devices so that the data transfer is unnecessary. In addition, the compiler library 240 can provide functions that eliminate that the statically defined data, allowing the compiler 120 to generate the compiled code 140 while performing fewer operations and in less time. The functions provided in the compiler library 240 can avoid problems associated with static folding using syntax trees (e.g., missed optimizations).

A type of data that can be transferred between two hardware devices is a memory allocation for a tensor object. A memory allocation may be defined by a layout including a shape and a stride. The shape of a tensor can refer to its dimensionality (e.g., by defining the number of elements along each dimension). For example, a three-dimensional tensor with a shape of (3, 4, 5) has three dimensions, with 3 elements in the first dimension, 4 in the second, and 5 in the third. This shape can be used in organizing the data structure in memory along with the stride. The stride of a tensor indicates how far apart elements of each dimension are stored in memory. Stride values can be used for efficient memory access, as the stride values can specify the step size needed to move from one element to the next within a specific dimension. For example, a two-dimensional tensor with a shape of (3, 3) (e.g., 3 rows and 3 columns) and a stride within the rows of 1 and within the columns of 3, e.g., (3, 1), indicates that to move from one element to the next within a row, the address can step by 1 memory unit, and to move from one row to the next, the memory address steps by 3 memory units.

In some implementations, the variables used to generate the shape and/or stride values within the system 100 are statically defined (e.g., provided by the developer as part of the processing instructions 220). The compiler 120 can optimize code by generating code for transferring only the dynamic variables (e.g., variables that receive a respective value at runtime) between the hardware devices of the host device 170 (e.g., and not transfer values for variables known to the compiler 120 at a time of compilation). The compiler 120 can alternatively generate code for which a first subset of the values for variables known to the compiler 120 at the time of compilation (e.g., static variables) are transferred and a second subset are excluded or not transferred. Code optimization (e.g., whether a static variable is included in transfer along the ABI 189) can depend on various factors related to the static variable, the code, and/or the hardware targets. For example, code optimization can depend on the size of the resulting code, whether the code generated is to be run in a debugger or deployed, or whether the static variable can be vectorized (e.g., included in a same array). with dynamic variables for operations. Additionally or alternatively, the compiler 120 can generate code to transfer the data in a flattened format. A flattened format can have one layer of variables and can be different from a nested format in which the structure or object can be composed of multiple other structures or objects. For example, an n-dimensional tensor layout can be defined as a shape and a stride, the shape having a parameter for the size of each dimension of the layout and the stride having a parameter for the memory step size while moving in each dimension of the layout. Such a layout can be flattened to a layout having the 2n parameters.

Table 1 defines example structures that can be generated in the compiled code 140 for layouts indicated as being transferred between the two devices. The second column provides the example structure in the LLVM format with only the dynamic values. It is noted that shape (?, 16) has been flattened from one structure layer to zero structure layers, and layout (shape (?,8), stride (1,?)) has been flattened from 2 structure layers to 1 structure layer.

TABLE 1
data transfer structures for various
forms memory/processing unit layouts.

| Layout in processing | Structure as defined by compiled |
|---|---|
| instructions 220 | code 140 prior to data transfer |
| shape(?, ?, 3, 4) | !llvm.struct<(i32, i32)> |
| shape(16, 32, 256) | !llvm.struct<( )> |
| shape(?, 16) | i32 |
| layout(shape(?, ?), stride(?, ?)) | !llvm.struct<(struct<(i32, i32)>, |
| | struct<(i32, i32)>)> |
| layout(shape(32, 8), stride(?, ?)) | !llvm.struct<(struct<( )>, |
| | struct<(i32, i32)>)> |
| layout(shape(?, 8), stride(1, ?)) | !llvm.struct<(i32, i32)> |

The compiler 120 can include an interface function identifier 122, a function selector 124, and/or a code generator 126, which can operate to efficiently convert the processing instructions 220 into the compiled code 140.

The interface function identifier 122 can identify functions in the processing instructions 220 that indicate data transfer or commands communicated between the CPU 180 and the GPU 190 (e.g., via the ABI 189). The interface function identifier 122 can, for example, compare function signatures of the processing instructions 220 with function signatures defined in the compiler library 240. Additionally or alternatively, the interface function identifier 122 can identify the parameters of the functions. The interface function identifier 122 may identify a structure within the processing instructions 220 associated with the function and determine that the information included in the structure is to be communicated between the CPU 180 and the GPU 190. In some implementations, the interface function identifier 122 can determine if a value of a variable of the structure is statically defined. The interface function identifier 122 can provide the information related to the identified function, its parameters, and/or if the respective variables for the parameters are statically defined to the function selector 124.

The function selector 124 can select a function from the compiler library 240 with a signature matching the function identified by the interface function identifier 122. The function selector 124 can receive an indication of the identified function and an indication of the structure of parameters. In some implementations, the function selector 124 receives (e.g., from the interface function identifier 122) an indication of whether or not the value of the variable is statically defined. The function selector 124 can select a function based on at least a function identifier (e.g., name, etc.) and the number of variables that are statically defined. The function selector 124 can use additional information in some implementations. For example, the function selector 124 can select a function based additionally on the total number of input parameters and/or the specific parameters that are statically defined.

The code generator 126 can generate a portion of the compiled code 140 using the selected function. A function from the processing instructions 220 can cause a number of operations to be generated within the compiled code 140. For some functions, a number of operations can be generated for the host program code 150 and a number of functions can be generated for the device program code 160. As the compiler 120 iterates over the various functions of the processing instructions 220, the code generator 126 creates respective code for the compiled code 140.

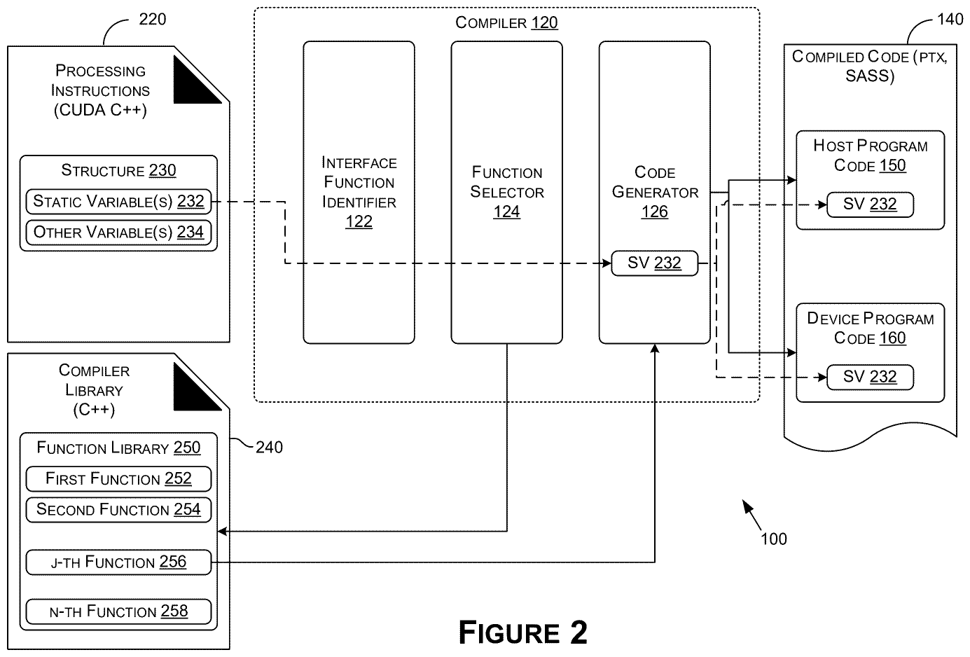

FIG. 2 is another functional block diagram of the system 100 suitable for implementing at least some implementations of the present disclosure. The block diagram of FIG. 2 shows additional detail related to how the compiler 120 generates the compiled code for the host program code 150 and the device program code 160 according to some implementations. In some implementations, the compiler 120 iteratively generates code from the processing instructions 220 function-by-function or line-by-line. Features of the components of the compiler 120 described herein can be performed several times during compilation of the processing instructions 220. For example, the features can be performed for each function of the processing instructions 220 and for each pass of the compiler (e.g., successive optimization passes and/or passes to intermediate code representations between the processing instructions 220 and the compiled code 140).

The interface function identifier 122 can receive a function from the processing instructions 220. The interface function identifier 122 can process functions sequentially, for example, by using a program counter to track the latest function analyzed. After code generation for the previous function (e.g., operation), the interface function identifier 122 can request the next function for processing. Some functions can include input variables defining parameters (e.g., arguments) of the function. The parameters of the functions can be arranged as a grouping of variables (e.g., a structure 230) that can have a number of static variables 232 (e.g., with known values during compilation) and/or a number of other variables 234 (e.g., dynamic values). The interface function identifier 122 can identify the static variables of the parameters.

Static variables can be identified by propagating a binding attribute (e.g., static or dynamic) through each function converted (e.g., lowered to a different language or syntax). The binding attribute of the output variables can be calculated based on the binding attribute of the input variables. For example, the product of binding attribute of a product output can be static if both the multiplier and the multiplicand inputs are static. If either or both inputs to a multiplication function are dynamic the output can also be dynamic. The interface function identifier 122 can identify static variables and provide information related to which variables are static to the function selector 124 for further processing. In some implementations, the code generator 126 determines the binding attribute of output variables for the functions for which the code generator 126 generates code.

The function selector 124 can determine code to execute to generate the compiled code 140 (e.g., the host program code 150 and the device program code 160). The function selector 124 can select a function that communicates only the parameters or variables that are not statically defined (e.g., the dynamic variables that receive their respective value at runtime). Static values, alternatively, can be provided to both the host program code 150 and the device program code 160 separately and can be combined with the dynamic variables after data is communicated. The function selector 124 can receive information from the interface function identifier 122 related to the function (e.g., operation, etc.) for which code is to be generated as well as the positions (e.g., within a list of function arguments) of the static and dynamic variables.

The function selector 124 may select a function for generating the compiled code 140 that is defined in the compiler library 240. For example, the function selector 124 can select a function from a function library 250, including a first function 252, a second function 254, a j-th function 256, or an n-th function 258. The function selector 124 can select the function based on the number of dynamic variables that the interface function identifier 122 has identified for communication between the CPU 180 and the GPU 190 (e.g., between the host program 182 and the device program 192).

In some implementations, the selected function includes code for performing a number of operations. The selected function can generate code to create the parameters (e.g., variables for the parameters) that are to be communicated between the CPU 180 and GPU 190. The selected function can generate output variables (e.g., and respective binding attributes) for later use during the compilation process of the compiler 120. The selected function can generate code to generate code that communicates parameters (e.g., dynamic variables) between the CPU 180 and the GPU 190. The selected function can generate code (e.g., for the receiving device) to combine one or more static variables (e.g., the static variables 232) with the dynamic variables received (e.g., the other variables 234).

In some implementations, the interface function identifier 122 can identify code in the processing instructions 220 that defines a layout of memory within the host device defined by a shape and a stride. A number of the parameters can be static and a number of the parameters can be dynamic. For example, the interface function identifier 122 may identify a function such as.: % s=cute.make_stride (% w, % z, % u, % y, % v, % x): (i32, i32, i32, i32, i32, i32)->!cute.stride<“(?, (10,?), (9, (3,?)), ((?, 4), (?,?)), 19)”>.

The function selector 124 can select a function can generate code for creating variables or a structure for communication between the devices (e.g., the CPU 180 and the GPU 190). The function, for example, can generate code that creates a structure with only the dynamic variables:

```
%0 = llvm.mlir.undef : !llvm.struct<(i32,
  struct<(struct<( )>, i32)>),
  struct<(struct<( )>, struct<(struct<( )>, i32)>>,
  struct<(struct<(i32, struct<( )>)>, struct<(i32, i32)>)>,
  struct<( )
>
```

Alternatively, the function, for example, can generate code that creates a structure with only the dynamic variables and is flattened to use a structure with only one layer:

$$\%0 = llvm . mlir . undef \text{:} ! llvm . struct < ( i 32 , i 32 , i 32 , i 32 , i 32 , i 32 ) >$$

The advantage of communicating only the dynamic variables can by shown by way of example with the code below. If the static and dynamic variables were communicated, the source (e.g., sending) device would perform operations defined by:

llvm.func @nested_dynamic_stride(%arg0: i32, %arg1: i32, %arg2: 132,
%arg3:132, %arg4: 132, %arg5: 132) {
%0 = llvm.mlir.undef : !llvm.struct<(...)>
%1 = llvm.insertvalue %arg2, %0[0] : !llvm.struct<(...)>
%2 = llvm.mlir.constant(10 : 132) : i32
%3 = llvm.insertvalue %2, %1[1, 0] : !llvm.struct<(...)>
%4 = llvm.insertvalue %arg5, %3[1, 1] : !llvm.struct<(...)>
%5 = llvm.mlir.constant(9 : i32) : i32
%6 = llvm.insertvalue %5, %4[2, 0] : !llvm.struct<(...)>
%7 = llvm.mlir.constant(3 : 132) : i32
%8 = llvm.insertvalue %7, %6[2, 1, 0] : !llvm.struct<(...)>
%9 = llvm.insertvalue %arg0, %8[2, 1, 1] : !llvm.struct<(...)>
%10 = llvm.insertvalue %arg4, %9[3, 0, 0] : !llvm.struct<(...)>
%11 = llvm.mlir.constant(4 : i32) : i32
%12 = llvm.insertvalue %11, %10[3, 0, 1] : !llvm.struct<(...)>
%13 = llvm.insertvalue %arg1, %12[3, 1, 0] : !llvm.struct<(...)>
%14 = llvm.insertvalue %arg3, %13[3, 1, 1] : !llvm.struct<(...)>
%15 = llvm.mlir.constant(19 : i32) : i32
%16 = llvm.insertvalue %15, %14[4] : !llvm.struct<(...)>
llvm.return

If only dynamic variables are communicated, the source (e.g., sending) device would perform operations defined by:

llvm.func @nested_dynamic_stride(%arg0: i32, %arg1: i32, %arg2: 132,
%arg3: 132, %arg4: 132, %arg5: 132) {
%0 = llvm.mlir.undef : !llvm.struct<(i32, i32, i32, i32, i32, i32)>
%1 = llvm.insertvalue %arg2, %0[0] : !llvm.struct<(i32, i32, i32, i32, i32, i32)>
%2 = llvm.insertvalue %arg5, %1[1] : !llvm.struct<(132, i32, i32, i32, i32, i32)>
%3 = llvm.insertvalue %arg0, %2[2] : !llvm.struct<(i32, i32, i32, i32, i32, i32)>
%4 = llvm.insertvalue %arg4, %3[3] : !llvm.struct<(i32, i32, i32, i32, i32, i32)>
%5 = llvm.insertvalue %arg1, %4[4] : !llvm.struct<(i32, i32, i32, i32, i32, i32)>
%6 = llvm.insertvalue %arg3, %5[5] : !llvm.struct<(i32, i32, i32, i32, i32, i32)>
llvm.return

and having fewer than half the number of operations to perform.

The code generator 126 can use the selected function to generate the compiled code 140. For example, the code generator 126 can execute the code defined by the selected function. In some implementations, the code generator 126 generates a device program code 160 and a host program code 150. The host program code 150 can define operations for the transfer of parameters from the host program 182 to the device program 192. Additionally or alternatively, the device program code 160 can define operations for the transfer of parameters from the device program 192 to the host program 182. The code generator 126 can generate a device program code 160 with one or more static variables (e.g., the static variables 232) embedded (e.g., defined, hard coded, etc.) within a respective operation. When the host program 182 defined by the host program code 150 communicates dynamic variables (e.g., representing parameters of an operation) to the device program 192 defined by the device program code 160, the device program 192 can augment the parameters of the operation with the known static variables. Communication from the device program 192 to the host program 182 over the ABI 189 can occur using similar operations.

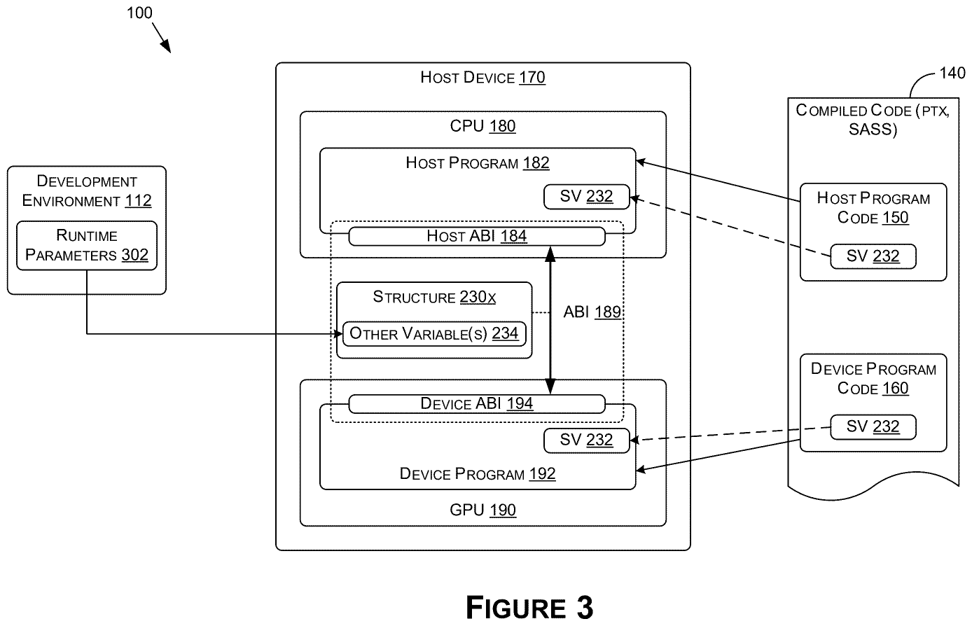

FIG. 3 is a function block diagram of the host device with ABI suitable for use in implementing at least some implementations of the present disclosure. FIG. 3 shows a relationship between the compiled code 140 and the processes running on the host device 170 according to some implementations. The host program code 150 can provide instructions for the host program 182 and the device program code 160 can provide instructions for the device program 192.

In some implementations, the host program 182 includes a host ABI 184. The host ABI 184 can communicate various parameters with the device program 192 via the ABI 189. Similarly, the device program 192 can include a device ABI 194 that can communicate parameters with the host program 182 via the ABI 189.

The compiled code 140 may define operations for the host program 182 or the device program 192 to communicate the parameters of a structure 230 between the processes. As described previously, the structure 230 may include static variables 232 and a number of other variables 234. In some implementations, the static variables 232 are not communicated via the ABI 189; alternatively, a different structure 230x can be communicated over the ABI 189. The different structure 230x can include the number of other variables 234 without the static variables 232. For example, the development environment 112 can provide an interface for defining runtime parameters 302. The runtime parameters 302 can be used to populate the different structure 230x with values for the other variables 234. In some implementations, only a portion of the static variables 232 are removed from the structure 230 to form the different structure 230x. The static variables 232 removed can depend on code optimizations. For example, some static variables may be communicated over the ABI 189, to limit the amount of operations stored in memory of the host device 170.

The static variables 232 that are not included in the different structure 230x communicated over the ABI 189 can be generated by the process receiving the different structure 230x (e.g., the host program 182 or the device program 192). For example, the static variables 232 can be statically defined in the compiled code 140. During execution, the receiving process can generate the static variables 232 from the static definition and augment the parameters communicated over the ABI 189. In this way, the static variables 232 can be communicated via the compiled code 140 at the time of compilation and the number of other variables 234 (e.g., including dynamic variables) can be communicated over the ABI 189 at runtime. Advantageously, explicitly including the function library 250 in the compiler library 240 can increase compiler efficiency. For example, the code optimized functions can be explicitly defined and can allow the compiler 120 to perform fewer optimization operations.

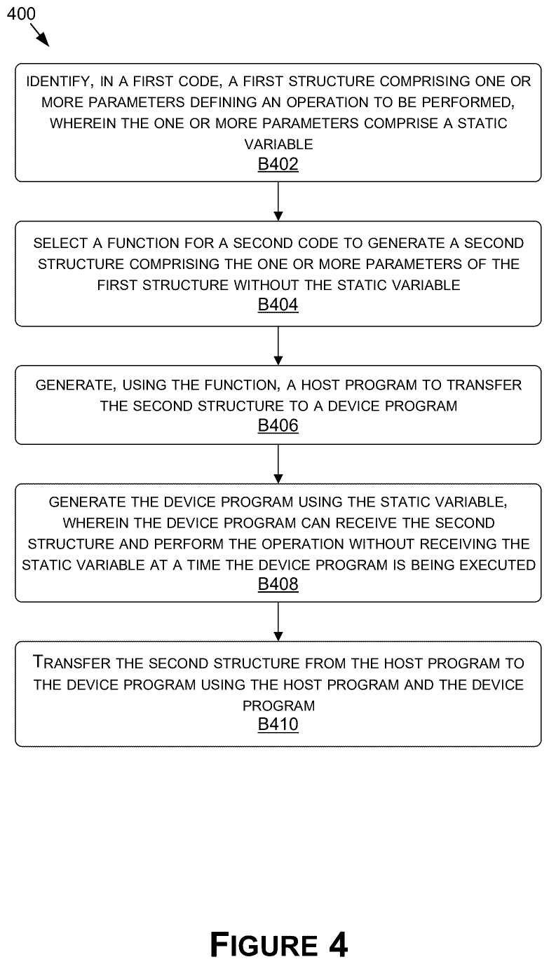

Now referring to FIG. 4, each block of a method 400, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the method 400 is described, by way of example, with respect to the system of FIG. 1. However, this method may additionally or alternatively be executed by any one system, or any combination of systems, including, but not limited to, those described herein.

FIG. 4 is a flow diagram showing the method 400 for generating code in accordance with some implementations of the present disclosure. In some implementations, generating the code can include generating code describing an ABI, for example, to communicate data, commands, and/or parameters for commands between at least two compute devices (e.g., hardware, CPUs, GPUs, or any other equipment that can be included in a host.). In some implementations, the method 400 is performed by the compiler 120 and the code is deployed to the host device 170 and/or the CPU 180 or GPU 190 thereof.

In some implementations, the method 400 can be repeated for several operations defined in a first code (e.g., text for a higher-level programming language). For example, the operations defined in the first code can be processed individually (e.g., sequentially or in parallel) during compilation. The method 400 can be used for operations that satisfy one or more criteria (e.g., specify transfer of data between two devices, include arguments that are statically defined, etc.). Other methods may be used to generate code for operations that do not satisfy the one or more criteria.

The method 400, at block B402, can include identifying, in a first code, a first structure comprising one or more parameters defining an operation to be performed, wherein the one or more parameters comprise a static variable. The operation can be a function in the first code (e.g., the processing instructions 220), defined using one or more parameters, for example, grouped by a structure. The method 400, at the block B402 can include identifying the parameters that are static variables and the parameters that are dynamic variables. For example, the interface function identifier 122 can perform the steps at block B402. Additionally or alternatively, an index, identifier, location, etc. of the static variables can be identified at the block B402 and used for processing at later blocks (e.g., when code is generated).

The method 400, at block B404, can include selecting a function for a second code to generate a second structure comprising the one or more parameters of the first structure without the static variable. The function selected, for example, can be used to generate code that can be implemented by a host device host device 170 (e.g., a CPU 180 or a GPU 190). The function can be selected from one or more functions included in a function library defined within a higher-level language (e.g., a C language, an intermediate representation, etc.). The function can provide instructions to a compiler 120 to generate instructions for the second code. For example, the function may provide instructions for generating code within a dialect of low-level virtual machine (LLVM), PTX, and/or SASS. In some implementations, the function selector 124 of the compiler 120 performs the steps of the block B404.

Advantageously, the compiler 120 is provided with instructions to generate code that creates the structure identified at block B402 without the static variables. Such instructions can eliminate the amount of time the compiler uses to optimize code. For example, the operation can instruct data to be communicated between two devices of a host (e.g., the CPU 180 and GPU 190 of the host device 170). For such instructions, the method 400, at the block B404, can generate a second structure to communicate between the devices without the statically defined variables and code for creating these variables does not need to be generated.

The method 400, at block B406, can include generating, using the function, a host program to transfer the second structure to a device program. For example, the code generator 126 of the compiler 120 can perform the steps of the block B406 to generate code for the host program code 150. The method 400, at block B408, can include generating the device program using the static variable. The device program can receive the second structure and perform the operation without receiving the static variable at a time the device program is being executed. During generation of the device program, the device program may be provided with the static variable during the compilation process. For example, if a command is communicated from the host program to the device program during operation, the device program can perform the operation by combining the second structure received (e.g., without the static variable) with the predefined static variable provided to the program code (and thus the executing device program). The steps of the block B408 can also be performed by the code generator 126.

The method 400, at block B410, can include transferring the second structure from the host program to the device program using the host program and the device program. The steps performed at block B410 can include all steps leading to the actual data transfer (e.g., the communication of the second structure). The steps can include, for example, communicating the host (e.g., the host device 170) and initiating execution of the compiled code 140 (e.g., the second code). After receiving the second structure the device program can use the second structure along with the predefined static variables to perform the operation. For example, the steps of the block B410 can be performed by the host device 170 (e.g., the CPU 180 may execute the host program 182 while the GPU 190 executes the device program 192) and the parameters can be communicated over the ABI 189.

It is contemplated that while the method 400 is described for a host program transferring information (e.g., parameters of an operation) to the device program, the device program can also communicate information to the host program. In some implementations and/or processing instructions 220, the device program can request that the host program perform a particular operation or return results back to the host program. Both directions of data transfer are within the scope of the present disclosure.

During execution, a number of advantages can be provided when code is generated using the method 400 (and/or the system 100). Advantages include reduced memory usage and/or reduced computational time (e.g., fewer iterations). For example, communicating less information can result in fewer shared memory locations (e.g., between the CPU 180 and the GPU 190) being used and can result in more efficient execution (e.g., preventing the need to reallocate memory between some operations). In addition, the static variables do not need to be created within the host (sending) program as they are not communicated. In some implementations, the number of operations to receive the second structure is reduced compared to the first structure at least in part due to the smaller data payload. Method 400 can also provide compilation improvements. As described previously, the function for the second code used to generate the second structure is provided to the compiler 120 by the compiler library 240 in an already optimized format.

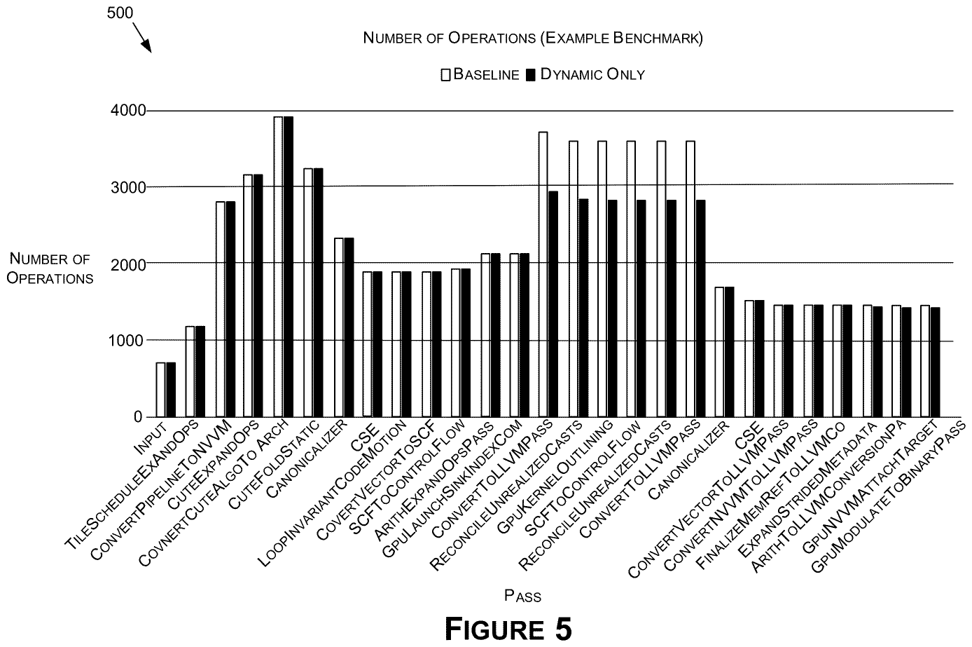

FIG. 5 shows a bar chart 500 comparing the operations associated with compiling for a baseline system and a system with a library of functions for communicating only dynamic variables over an ABI (e.g., according to the system 100 and/or the method 400). The bar chart 500 shows significant improvement in some passes (e.g., phases) of the compilation process. For example, the convert to LLVM pass can include approximately 20% fewer operations when the compiler 120 uses the compiler library 240 as described herein. Overall, the system 100 and method disclosed can save up to 2% of total compilation time.

In some implementations, the systems and methods described herein can be performed within a development environment for configuring machine learning models (e.g., transformer models, recurrent neural networks, reinforcement learning models, large language models, etc.). For example, the compiler system and compilation methods described herein can be packaged with tools for developing machine learning models including, but not limited to, integrated development environments for high-level languages (e.g., Python, C languages, etc.) and/or with libraries designed for the development of code targeting GPUs (e.g., NVIDIA's CUDA). The systems and methods described herein may also be performed within a simulation environment. For example, the compiler system and compilation methods described herein can compile code for a GPU that is used to calculate system states (e.g., temperatures, velocities, etc.) of a machine, equipment, or another real-world object within a simulated environment. The simulations can provide data by which the performance of other algorithms (e.g., machine vision models, vehicle control algorithms, etc.) is tested prior to deployment. The compiled code can also be used to generate renderings of three-dimensional models of the real-world objects as the simulation progresses.

In some implementations, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the compiler system and compilation methods described herein can be used within a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

The LLMs/SLMs/VLMs/MMLMs/etc. may be trained and/or executed using code generated by the compiler 120. For example, any of the systems or methods described herein may be implemented within a development environment capable of or designed for producing machine learning models. The machine learning models may include transformer models, recurrent neural network models, long short-term memory models or any other model architecture described herein. The development environment may be used for or designed for generating machine learning models geared towards a variety of applications including LLMs/SLMs/VLMs/MMLMs, automotive applications, simulation and testing, or other applications described herein.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a SLM, a VLM, a multi-modal LM, etc.). The example generative language model system 600 may be implemented, for example, by code targeting a CPU and/or GPU generated by the system 100 and/or the compiler 120.

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 630 (e.g., LLM/SLM/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/SLM/VLM/MMLM/etc. with external knowledge, so that answers to specific questions or queries or requests are more relevant-such as in a case where specific knowledge is required. The RAG component 692 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 601 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features-such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use- or capable of accessing or using-plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources-such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

In some implementations, instructions for executing the example LMs 630 are generated by the system 100. For example, the LMs 630 may be specified within a deep learning framework 110 within which the compiler 120 is integrated. Additionally or alternatively, the deep learning framework 110 can communicate a representation of the processing instructions for any of example LMs 630. The compiler 120 can convert processing instructions into compiled code capable of executing on host device 170 (e.g., the GPU 190 or the CPU 180).

### Example Computing Device

FIG. 7 is a block diagram of an example computing device(s) 700 suitable for use in implementing some embodiments of the present disclosure. The computing devices 700, for example, can implement any of the components of the system 100. The computing devices 700 may implement the deep learning framework 110, the compiler 120, and/or the host device 170. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708. In some implementations, instructions are generated by the compiler 120 and communicated to the CPU(s) 706 and/or the GPU(s) 708 (e.g., the GPU 190 and the CPU 180 of the host device 170).

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

In some embodiments, a number of computers or other computing resources (e.g., of the example data center 800). The components (e.g., the deep learning framework 110, the compiler 120, and/or the host device 170) may be distributed over any number of resources within the example data center 800. A single component may be implemented by a single resource or by more than one resource. Additionally or alternatively, a single resource may implement more than one of the components of the system 100. In some embodiments, the multiplicity of each component type is increased to meet the current demand for that functionality. For example, several instances of the compiler 120 may be operating within the example data center 800 at any point in time. Each instance may be generating code for a different set of processing instructions, for a different application, etc.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
identify, in a first code, a first structure comprising one or more parameters defining an operation to be performed, wherein the one or more parameters comprise a static variable;
select a function for a second code to generate a second structure comprising the one or more parameters of the first structure without the static variable;
generate, using the function, a first program to transfer the second structure to a second program; and
generate the second program using the static variable, wherein the second program is to receive the second structure and perform the operation without receiving the static variable at a time the second program is being executed.

2. The one or more processors of claim 1, wherein the first program is a host program to be executed by a central processing unit and the second program is a s program is to be executed on a graphics processing unit.

3. The one or more processors of claim 1, wherein the operation comprises a memory allocation within the second program.

4. The one or more processors of claim 3, wherein the one or more parameters indicate a shape and a stride for the memory allocation.

5. The one or more processors of claim 1, wherein the first structure comprises a plurality of nesting levels for the one or more parameters and the second structure comprises the one or more parameters of the first structure without the static variable at a single nesting level.

6. The one or more processors of claim 1, wherein the second code is of an intermediate programming language and generated from the first code used to generate the second program and the first program.

7. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

8. A system comprising one or more processors to:
identify, in a first code, a first structure comprising one or more parameters defining an operation to be performed, wherein the one or more parameters comprise a static variable;
select a function for a second code to generate a second structure comprising the one or more parameters of the first structure without the static variable;
generate, using the function, a first program to transfer the second structure to a second program; and
generate the second program using the static variable, wherein the second program is to receive the second structure and perform the operation without receiving the static variable at a time the second program is being executed.

9. The system of claim 8, wherein the first program is a host program to be executed by a central processing unit and the second program is a device program to be executed on a graphics processing unit.

10. The system of claim 8, wherein the operation comprises a memory allocation within the second program.

11. The system of claim 10, wherein the one or more parameters indicate a shape and a stride for the memory allocation.

12. The system of claim 8, wherein the first structure comprises a plurality of nesting levels for the one or more parameters and the second structure comprises the one or more parameters of the first structure without the static variable at a single nesting level.

13. The system of claim 8, wherein the second code is of an intermediate programming language and generated from the first code used to generate the second program and the first program.

14. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A method comprising:
identifying, in a first code, a first structure comprising one or more parameters defining an operation to be performed, wherein the one or more parameters comprise a static variable;
selecting a function for a second code to generate a second structure comprising the one or more parameters of the first structure without the static variable;
generating, using the function, a first program to transfer the second structure to a second program; and
generating the second program using the static variable, wherein the second program is to receive the second structure and perform the operation without receiving the static variable at a time the second program is being executed.

16. The method of claim 15, wherein the first program is a host program to be executed by a central processing unit and the second program is a device program is to be executed on a graphics processing unit.

17. The method of claim 15, wherein the operation comprises a memory allocation within the second program and the one or more parameters indicate a shape and a stride for the memory allocation.

18. The method of claim 15, wherein the first structure comprises a plurality of nesting levels for the one or more parameters and the second structure comprises the one or more parameters of the first structure without the static variable at a single nesting level.

19. The method of claim 15, wherein the second code is of an intermediate programming language and generated from the first code used to generate the second program and the first program.

20. The method of claim 15, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
